(19) United States
(12) Patent Application Publication
(10) Pub. No.: US 2010/0115799 A1
(43) Pub. Date: May 13, 2010

(54) Shoe Apparatus

(76) Inventors: Brady Welter, Fort Atkinson, WI (US); Ralph R. Welter, Fort Atkinson, WI (US)

Correspondence Address: HARSHAW RESEARCH, INC., 210 W. TECUMSEH STREET, OTTAWA, KS, 66067, US

(21) Appl. No.: 12/270,526

(22) Filed: Nov. 13, 2008

(51) Int. Cl. A43B 23/00; H04M 1/22; F21V 21/08

(52) U.S. Cl. 36/137; 36/139; 362/86; 362/103

(57) ABSTRACT

A shoe apparatus includes a shoe sole and a shoe upper atop the shoe sole. The shoe apparatus includes at least one sensor for determining when at least a portion of the shoe sole is compressed and includes at least one speaker. A processor is in data communication with the at least one sensor and the at least one speaker, the processor having programming to actuate the at least one speaker to output sound when the at least one sensor detects the compression. The processor may also be in communication with at least one light, the processor having programming to actuate the light when the sensor detects that a wearer has taken a step. At least one battery is in electrical communication with the at least one speaker and the processor.

### BACKGROUND OF THE INVENTION

This application relates generally to a shoe apparatus and, more particularly, to a shoe or aftermarket device for a shoe having sensors and audio or visual effects that are actuated when the sensors detect shoe movements indicative of steps, stomps, or dance moves.

Dancing is a physical activity that provides personal enjoyment and exercise to the person who is dancing. Moving the body in time with a rhythm is found in virtually all cultures and is perhaps an innate physical and emotional response in all people. Traditional exercise, on the other hand, is not usually undertaken with the same enthusiasm despite its importance to a person's general health and well-being. While organized exercise, such as team sports, may be engaged in with enhanced enthusiasm, many people do not participate in such exercise because they do not have sufficient opportunity or because they simply lack the motivation to engage in available opportunities.

Various devices have been proposed in the art for attempting to stimulate exercise by bringing sight and sound effects to footwear in an attempt to heighten enjoyment of moving one's feet. Although assembly effective for their intended purposes, the existing devices and proposals do not fully distinguish between heel or toe movements, cannot sense the strength of a movement, or do not provide variations of light and sound according to these sensations.

Therefore, it would be desirable to have a shoe apparatus that would bring enhanced enjoyment, entertainment, and motivation to moving one's feet. Further, it would be desirable to have a shoe apparatus that would sense different types and strengths of foot movement and provide selective modes of audio and visual effects accordingly. In addition, it would be desirable to have a shoe apparatus that may be applied to and used with traditional shoes.

### SUMMARY OF THE INVENTION

A shoe apparatus according to the present invention includes a shoe sole and a shoe upper atop the shoe sole. The shoe apparatus includes at least one sensor for determining when at least a portion of the shoe sole is compressed and includes at least one speaker. A processor is in data communication with the at least one sensor and the at least one speaker, the processor having programming to actuate the at least one speaker to output sound when the at least one sensor detects the compression. The processor may also be in communication with at least one light, the processor having programming to actuate the light when the sensor detects that a wearer has taken a step. At least one battery is in electrical communication with the at least one speaker and the processor.

Therefore, a general object of this invention is to provide a shoe apparatus that motivates a user to move his feet by providing audio and visual stimulus when compression or pressure is detected by sensors.

A further object of this invention is to provide a shoe apparatus, as aforesaid, having sensors situated in the sole of the apparatus for detecting when a wearer has taken a step.

A still further object of this invention is to provide a shoe apparatus, as aforesaid, having a processor and audio/visual components that may be actuated when the sensors detect various movements of the shoe apparatus.

Yet another object of this invention is to provide a shoe apparatus, as aforesaid, that can motivate a wearer to move his feet by providing stimulating audio and visual effects as a result.

A further object of this invention is to provide a shoe apparatus, as aforesaid, that is cost effective and user-friendly to use.

A still further object of this invention is to provide a shoe apparatus, as aforesaid, having a harness that may be attached to a shoe and which may house the processor, speaker, and lights.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is a top perspective view of a shoe apparatus according to a preferred embodiment of the present invention;

FIG. 1b is a bottom perspective view of the shoe apparatus as in FIG. 1a;

FIG. 2a is a top perspective view of a shoe apparatus as in FIG. 1a according to another embodiment of the present invention with electronic components housed in a harness.

FIG. 2b is bottom perspective view of the shoe apparatus as in FIG. 2a;

FIG. 3a is an exploded view of the shoe apparatus as in FIG. 1a;

FIG. 3b is a perspective view of a remote unit according to the present invention;

FIG. 4a is a side view of a sensor as in FIG. 3a;

FIG. 4b is a sectional view taken along line 4b-4b as in FIG. 4a;

FIG. 5 is another bottom perspective view as in FIG. 1b with a portion of the sole removed;

FIG. 6a is a block diagram of the electronic components of the shoe apparatus according to the present invention; and

FIG. 6b is another block diagram of the electronic components according to another embodiment of the present invention.

### DESCRIPTION OF THE PREFERRED EMBODIMENT

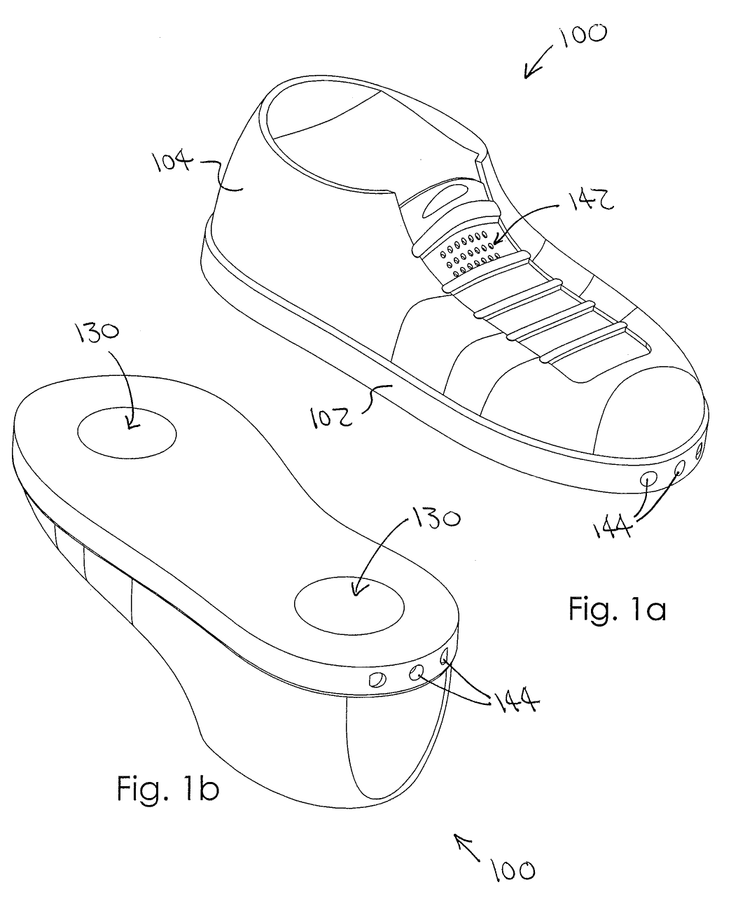

A shoe apparatus will now be described in detail with reference to FIG. 1a through FIG. 6b of the accompanying drawings. More particularly, a shoe apparatus 100 includes at least one sensor 130, a processor 140, and at least one speaker 142.

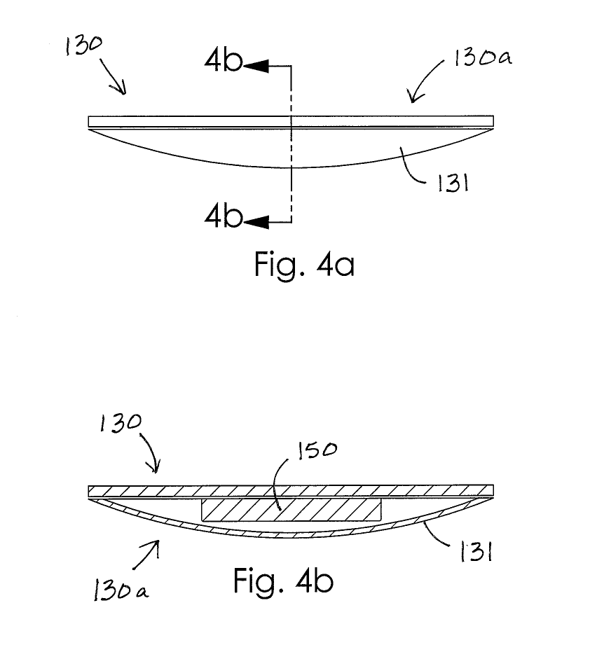

In some embodiments, as shown in FIGS. 1a, 1b, 3a, and 5, the shoe apparatus 100 includes a shoe sole 102 and a shoe upper 104 atop the shoe sole 102. The sensor(s) 130 are housed in the shoe sole 102 for determining when a wearer has taken a step. More particularly, the sensor(s) 130 determine (directly or indirectly) when at least a portion of the shoe sole 102 is compressed, such as by detecting an influx of pressure on the sensor(s) 130. Various sensors 130 may be used, including (but not limited to) switches 130a and piezoelectric transducers. A switch 130 may, for example, complete an electrical circuit upon a movable member being compressed. As shown in FIGS. 4a and 4b, for example, compression causes wall 131 to interact with a battery 150 and complete a circuit. A piezoelectric transducer, on the other hand, emits a voltage when pressure is applied.

As shown in FIG. 1b, a plurality of sensors 130 may be included. The sensors 130 may be spread apart to determine when different regions of the shoe sole 102 are compressed. While two sensors 130 are shown in FIG. 1b, it should be understood that many sensors 130 may be included to survey additional regions of the shoe sole 102. The sensor(s) 130 may also determine amounts of compression/pressure. For example, if switches 130a are used, an array of switches 130a that require different amounts of compression to force walls 131 to complete the circuits may be included. If piezoelectric transducers are used, the voltage emitted is generally proportional to the force applied, so the resulting voltages may indicate the amounts of compression/pressure.

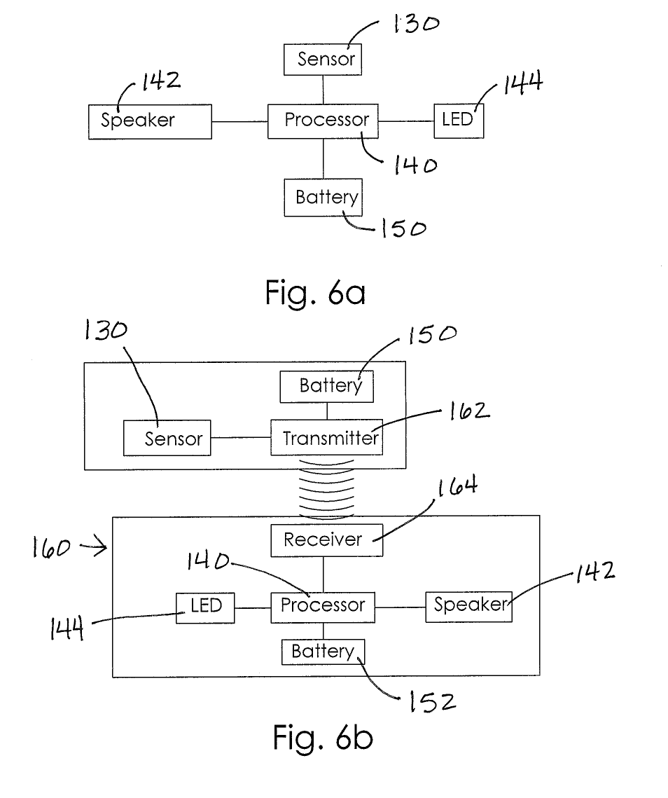

The processor 140 is in data communication with the sensor(s) 130 and the speaker(s) 142, as shown in FIG. 6a. The processor 140 may further be in data communication with at least one light (e.g., LED) 144 (FIG. 6a), and means are included for powering the processor 140, speaker(s) 142, and light(s) 144. The processor 140 has programming to actuate the speaker(s) 142 to output sound and/or to actuate the light(s) 144 when the sensor(s) 130 determine that the wearer has taken a step (i.e., when compression/pressure is detected by the sensor(s) 130). The processor 140 may also include programming to actuate the speaker(s) 142 and/or light(s) 144 to output sound based on determinations by the sensor(s) 130 regarding amounts of compression/pressure. In other words, the processor 140 may cause the speaker(s) 142 to output sound when a step is taken, and the sound that is output (e.g., volume, tone, sustain, etc.) may be affected based on the amount of compression/pressure determined by the sensor(s) 130. The sound may be further based on the speed or rhythm of steps detected by the sensor(s) 130, which sensor 130 detects compression/pressure, and other factors.

In the embodiment shown in FIGS. 1a and 1b, the processor 140, speaker(s) 142, light(s) 144, and powering device(s) (e.g., battery 150) are housed in the shoe sole 102 or the shoe upper 104. In such arrangements, the processor 140, speaker(s) 142, light(s) 144, and powering device(s) are in communication through wiring. FIG. 6a shows one appropriate electrical arrangement for the embodiment set forth in FIGS. 1a and 1b.

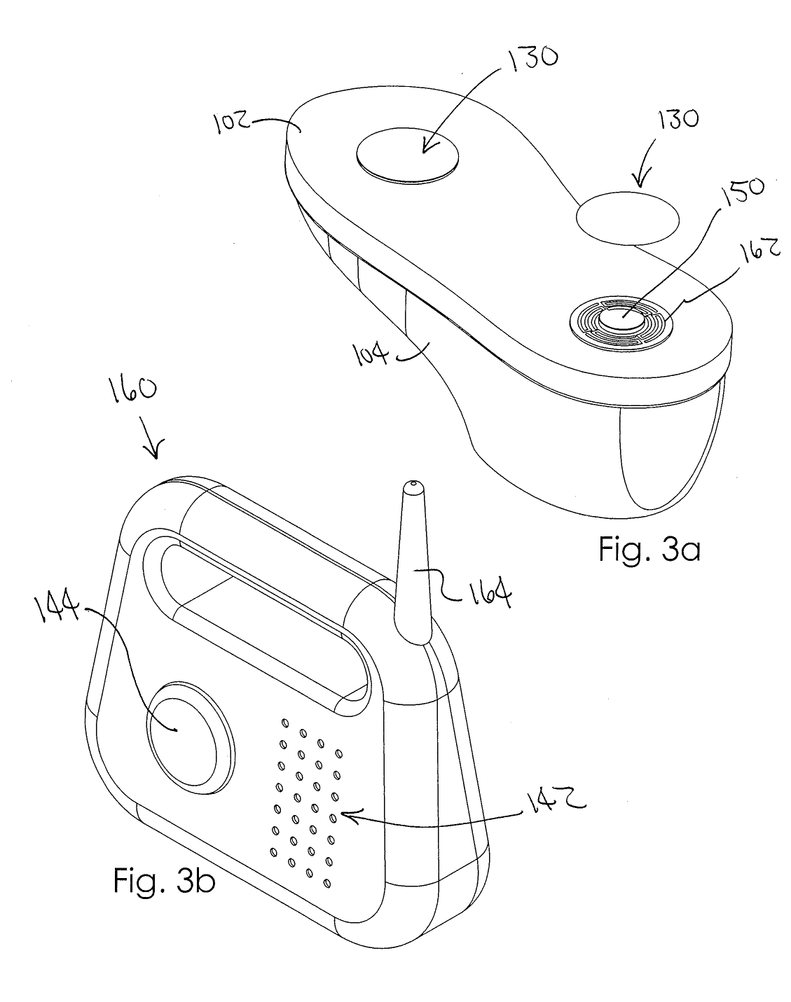

In another embodiment, shown in FIGS. 3a and 3b, the processor 140, speaker(s) 142, light(s) 144, and powering device(s) (e.g., battery 152) are housed in a remote unit 160 (i.e., a housing separate from the shoe sole 102 and the shoe upper 104). As shown in FIG. 6b, a transmitter 162 is in data communication with the sensor(s) 130 and a power source (e.g., battery 150), and a receiver 164 is in data communication with the processor 140; this provides data communication between the sensor(s) 130 and the processor 140.

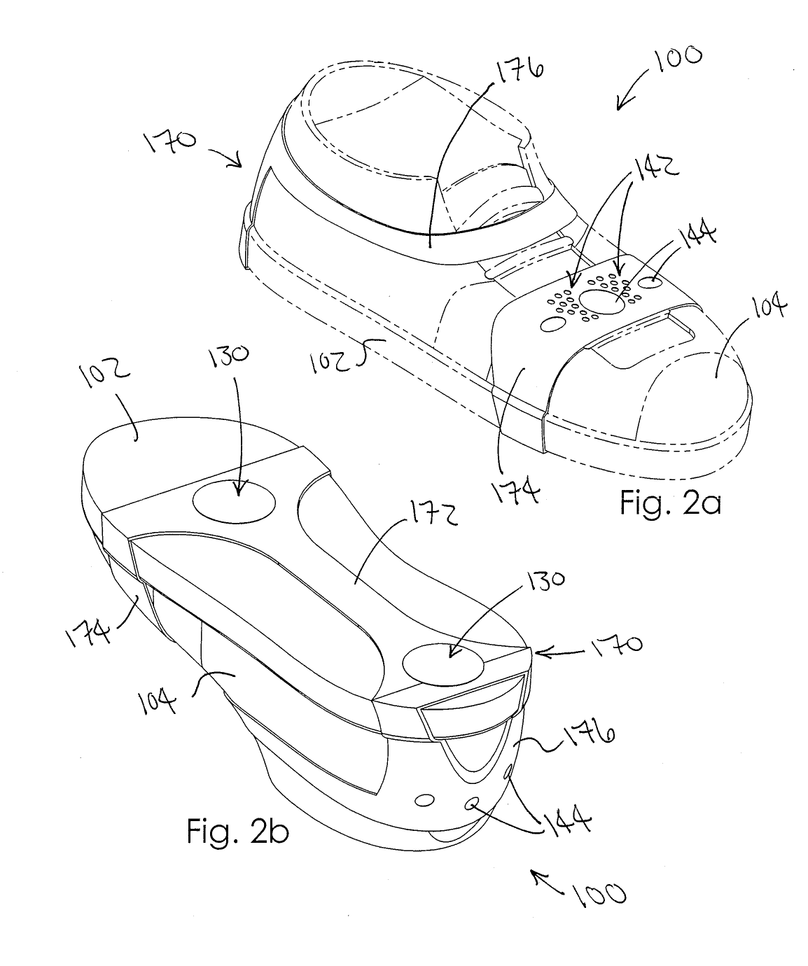

While the sensor(s) 130 are housed in the shoe sole 102 in the embodiments discussed above, other embodiments instead utilize a harness 170 but are otherwise generally similar. FIGS. 2a and 2b show the harness 170, which is configured for aftermarket attachment to the shoe sole 102 and the shoe upper 104. The harness 170 has a sole portion 172 configured for placement lowerly adjacent the shoe sole 102 (FIG. 2b), a forward strap 174 configured for attachment to the shoe upper 104 (FIG. 2a), and a rear strap 176 configured for attachment to the shoe upper 104 (FIG. 2a). The harness 170 may be resiliently elastic to attach to the shoe sole 102 and the shoe upper 104 without an adjustable fastening element (i.e., through stretching and contracting), or adjustable fastening elements (e.g., hook and loop fasteners, snaps, ties, etc.) may be included (e.g., in forward strap 174 and rear strap 176).

If the harness 170 is included, the sensor(s) 130 are housed in the harness 170 (i.e., in the harness sole portion 172), and the sensors 130 may be located at different regions of the harness sole portion 172 (FIG. 2b) to detect compression/pressure in various regions of the sole portion 172 and the adjacent shoe sole 102. While the harness 170 may house the processor 140, speaker(s) 142, and light(s) 144, as shown in FIGS. 2a and 6a, these elements may instead be housed in the remote unit 160 (FIG. 3b), as shown in FIG. 6b. If the remote unit 160 is used (FIG. 6b), the transmitter 162 is in data communication with the sensor(s) 130 and a power source (e.g., battery 150), and a receiver 164 is in data communication with the processor 140 to provide data communication between the sensor(s) 130 and the processor 140, similar to the embodiment of FIG. 3a discussed above.

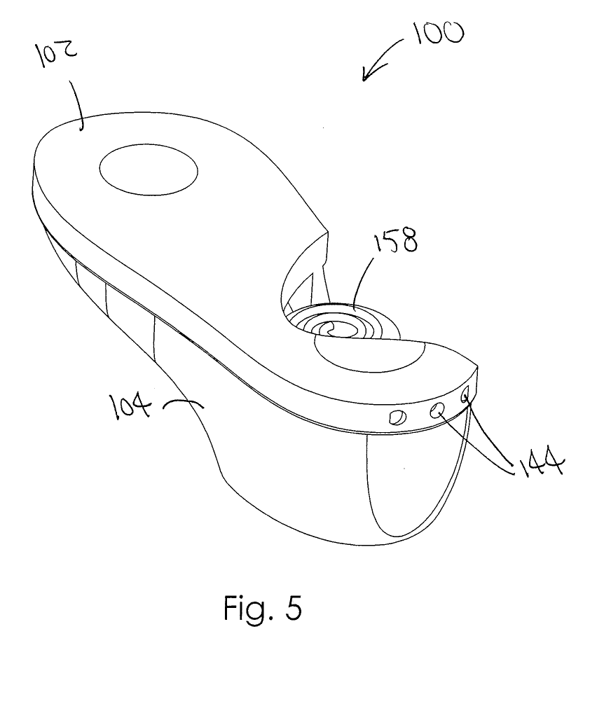

Turning to FIGS. 5 through 6b, regardless of whether the harness 170 is included or the sensor(s) are in the shoe sole 102, at least one power source is necessary. The battery 150 may be present in the shoe sole 102, the shoe upper 104, or the harness 170, and the other battery 152 may be in the remote unit 160. The batteries 150, 152 may be various power storage devices, and rechargeable batteries may be preferred. To have a rechargeable battery without a port for communicating with a charging source, the battery 150 in particular may be in selective electrical communication with a charging power source through inductive coupling. An element 158 for use in inductive coupling is shown in FIG. 5.

In use, the sensor(s) 130 detect a step (i.e., by detecting compression/pressure) and an amount of compression/pressure involved with the step, and the processor 140 actuates the speaker(s) 142 and the light(s) 144 in accordance with the timing of the step, amount of compression/pressure, location of compression/pressure, speed or rhythm of steps, and/or other factors. If the sensor(s) 130 are housed in the harness 170, the harness 170 must be coupled to the shoe sole 102 and the shoe upper 104 (as set forth above and shown in FIGS. 2a and 2b) before the sensor(s) 130 may detect the step. If the remote unit 160 is included, the transmitter 162 and the receiver 164 provide the communication between the sensor(s) 130 and the processor 140, as shown in FIG. 6b.

It is understood that while certain forms of this invention have been illustrated and described, it is not limited thereto except insofar as such limitations are included in the following claims and allowable functional equivalents thereof.

1. A shoe apparatus, comprising:
a shoe sole;
a shoe upper atop said shoe sole;
at least one sensor for determining when a wearer has taken a step;
a speaker;
a processor in data communication with said at least one sensor and said speaker, said processor having programming to actuate said speaker to output sound when said at least one sensor determines that the wearer has taken a step; and
means for powering said speaker and said processor.

2. The shoe apparatus of claim 1, further comprising a light in data communication with said processor, and wherein said processor includes programming to actuate said light when said at least one sensor determines that the wearer has taken a step.

3. The shoe apparatus of claim 1, wherein:
said at least one sensor is housed in said shoe sole;
said speaker is housed in either said shoe sole or said shoe upper; and
said processor is housed in either said shoe sole or said shoe upper.

4. The shoe apparatus of claim 1, further comprising a harness configured for aftermarket attachment to said shoe sole and said shoe upper, and wherein said at least one sensor is housed in said harness.

5. The shoe apparatus of claim 4, wherein said speaker and said processor are housed in said harness.

6. The shoe apparatus of claim 4, further comprising:
a transmitter in data communication with said at least one sensor;
a receiver in data communication with said processor; and
a remote unit separate from said shoe sole, said shoe upper, and said harness;
wherein said speaker, said processor, and said receiver are housed in said remote unit.

7. The shoe apparatus of claim 6, further comprising a rechargeable battery in electrical communication with said transmitter, said rechargeable battery being in selective electrical communication with a charging power source through inductive coupling.

8. The shoe apparatus of claim 4, wherein said harness includes:
a sole portion configured for placement lowerly adjacent said shoe sole;
a forward strap configured for attachment to said shoe upper; and
a rear strap configured for attachment to said shoe upper.

9. The shoe apparatus of claim 8, wherein one of:
(a) said harness is resiliently elastic to attach to said shoe sole and said shoe upper without an adjustable fastening element; or
(b) said harness includes an adjustable fastening element to attach said harness to said shoe sole and said shoe upper.

10. The shoe apparatus of claim 1, wherein said means for powering said speaker and said processor includes a rechargeable battery in electrical communication with said speaker and said processor, said rechargeable battery being in selective electrical communication with a charging power source through inductive coupling.

11. The shoe apparatus of claim 1, wherein said at least one sensor is a switch or a piezoelectric transducer.

12. The shoe apparatus of claim 1, wherein:
said at least one sensor is a plurality of sensors; and
said processor has programming to actuate said speaker to output sound based on which sensor determines that the wearer has taken a step.

13. The shoe apparatus of claim 1, wherein said speaker is a plurality of speakers.

14. A shoe apparatus, comprising:
a shoe sole;
a shoe upper atop said shoe sole;
at least one sensor for determining when at least a portion of said shoe sole is compressed;
at least one speaker;
a processor in data communication with said at least one sensor and said at least one speaker, said processor having programming to actuate said at least one speaker to output sound when said at least one sensor detects said compression; and
at least one battery in electrical communication with said at least one speaker and said processor.

15. The shoe apparatus of claim 14, wherein:
said at least one sensor is a plurality of sensors spread apart to determine when different regions of said shoe sole are compressed;
said plurality of sensors determine amounts of compression of said shoe sole regions; and
said processor has programming to actuate said speaker to output sound based on sensor determination of which shoe sole region is compressed and amount of compression.

16. The shoe apparatus of claim 14, further comprising:
a harness configured for aftermarket attachment to said shoe sole and said shoe upper;
a transmitter in data communication with said at least one sensor;
a receiver in data communication with said processor; and
a remote unit separate from said shoe sole, said shoe upper, and said harness;
wherein said at least one sensor and said transmitter are housed in said harness; and
wherein said speaker, said processor, and said receiver are housed in said remote unit.

17. A shoe apparatus, comprising:
a harness for aftermarket attachment to a shoe sole and a shoe upper, said harness having a sole portion configured for placement lowerly adjacent said shoe sole, a forward strap configured for attachment to said shoe upper, and a rear strap configured for attachment to said shoe upper;
at least one sensor for detecting an influx of pressure thereon, said at least one sensor being housed in said harness sole portion;
at least one speaker;
a processor in data communication with said at least one sensor and said at least one speaker, said processor having programming to actuate said at least one speaker to output sound when said at least one sensor detects said pressure; and
at least one battery in electrical communication with said at least one speaker and said processor.

18. The shoe apparatus of claim 17, further comprising:
a transmitter in data communication with said at least one sensor;
a receiver in data communication with said processor; and
a remote unit separate from said shoe sole, said shoe upper, and said harness;
wherein said speaker, said processor, and said receiver are housed in said remote unit.

19. The shoe apparatus of claim 18, further comprising a rechargeable battery in electrical communication with said transmitter, said rechargeable battery being in selective electrical communication with a charging power source through inductive coupling.

20. The shoe apparatus of claim 19, wherein:
said at least one sensor is a plurality of sensors, respective sensors being located at different regions of said harness sole portion; and
said processor has programming to actuate said speaker to output sound based on which sensor detects influx of pressure.
